(19) United States
(12) Patent Application Publication
(10) Pub. No.: US 2010/0312736 A1
(43) Pub. Date: Dec. 9, 2010

(54) Critical Branching Neural Computation Apparatus and Methods

(75) Inventor: Christopher Kello, Merced, CA (US)

Correspondence Address: Antoinette F. Konski;FOLEY & LARDNER LLP, 975 Page Mill Road, Palo Alto, CA, 94304-1013, US

(73) Assignee: The Regents of the University of California

(21) Appl. No.: 12/794,662

(22) Filed: Jun. 4, 2010

Related U.S. Application Data
(60) Provisional application No. 61/184,711, filed on Jun. 5, 2009.

(51) Int. Cl. G06N 3/06; G06N 3/04; G06N 3/08

(52) U.S. Cl. 706/25; 706/33; 706/26

(57) ABSTRACT

A neural network comprising artificial neurons interconnected by connections, wherein each artificial neuron is configured to receive an input signal from and send an output signal to one or more of the other artificial neurons through one of the connections; each input and output signal is either positive or negative valued; and each artificial neuron has an activation at a time point, the activation being determined by at least input signals received by the artificial neuron, output signals sent by the artificial neuron, and a plurality of weights, wherein at least one weight is self-tuned at the time point. Also provided are methods of tuning neural networks.

### CROSS-REFERENCE TO RELATED APPLICATIONS

This application claims the benefit under 35 U.S.C. §119(e) of U.S. Provisional application Ser. No. 61/184,711, filed Jun. 5, 2009, the contents of which is hereby incorporated by reference in its entirety.

### FIELD OF THE DISCLOSURE

Provided embodiments of the present disclosure generally relate to hardware or software based neural network systems and methods of tuning the neural network systems.

### BACKGROUND

Artificial neural networks are systems that function in a manner similar to that of the human nerve system. Like the human nerve system, the elementary elements of an artificial neural network include the neurons, the connections between the neurons, and the topology of the network. Artificial neural networks learn and remember in ways similar to the human process and thus show great promise in pattern recognition tasks such as speech and image recognition which are difficult for conventional computers and data-processing systems.

Artificial neural networks are generally composed of many non-linear computational elements that operate in parallel. It has been suggested that neural networks operate optimally near a critical point like that in a continuous phase transition in which an activity spreads as spiking from one neuron to the next neuron as a critical branching process (Haldman and Beggs (2005) Physical Rev. Let. 94:058101).

To optimize the performance of an artificial neural network, a balance has to be struck between unresponsive and overly responsive spiking by relating their dynamics to a critical branching process. Critical branching processes describe the occurrence of discrete, generic events over time, where each “ancestor” event may cause some number of subsequent “descendant” events, and descendants may become ancestors to subsequent events over time. Electrophysiological recordings of neural activity, both in vitro and in vivo, have provided evidence for critical branching dynamics. Probabilistic models of critical branching have been shown to simulate distributions of recorded neural activity, but these models were abstracted away from membrane potentials, action potentials, and synaptic connections. Thus they cannot serve as mechanistic models of neural computation. One critical branching model has been reported that uses linear integrate-and-fire neurons and a simple algorithm for tuning synaptic connection weights to the critical branching point. However, synaptic connections were restricted to being exclusively excitatory, which again prohibits the model from being used to simulate neural computation.

### SUMMARY OF THE DISCLOSURE

The disclosure, in one embodiment, provides a system, comprising, or alternatively consisting essentially of, or alternatively consisting of, a network of artificial neurons interconnected by connections, wherein:

each artificial neuron is configured to receive an input signal from and send an output signal to one or more of the other artificial neurons through one of the connections;

each input and output signal is either positive or negative valued; and

each artificial neuron has an activation at a time point, the activation being determined by at least input signals received by the artificial neuron, output signals sent by the artificial neuron, and a plurality of weights, wherein at least one weight is self-tuned at the time point.

Also provided is a computational system, comprising, or alternatively consisting essentially of, or alternatively consisting of:

a processor;

a memory coupled to the processor; computer code, loaded into the memory for execution on the processor, for implementing an artificial neural network, the artificial neural network having a plurality of artificial neurons interconnected by connections, wherein:

each neuron is configured to receive an input signal from and send an output signal to one or more of the other artificial neurons through one of the connections;

each input and output signal is either positive or negative valued; and

each artificial neuron has an activation at a time point, the activation being determined by at least input signals received by the neuron, output signals sent by the neuron, and a plurality of weights, wherein at least one weight is self-tuned at the time point.

In one aspect, the systems of this disclosure further comprise an external signal device wherein one or more artificial neurons is configured to receive an input signal from the external signal device. In another aspect, the systems of this disclosure further comprise an external receiving device wherein one or more artificial neurons sends an output signal to the external receiving device. In yet another aspect, the systems of this disclosure further comprise a control unit, the control unit having a connection to each artificial neuron.

In some embodiments, the input signals determining the activation of the artificial neuron are input signals received by the artificial neuron at a prior time point preceding the time point. In some embodiments, the output signals determining the activation of the artificial neuron are output signals sent by the artificial neuron at a prior time point preceding the time point.

In one aspect of the disclosure, each connection is a unidirectional connection.

In one aspect of the disclosure, each weight is independently self-tuned. The weights can be self-tuned at a time point so that a non-zero output signal sent by each artificial neuron is followed by one non-zero output signal among all artificial neurons to which the artificial neuron sends an output signal. In some embodiments, the non-zero output signal is a spike.

In some embodiments, output signal sent by each artificial neuron can be determined by at least the activation of the artificial neuron and a threshold parameter. The threshold parameter can be pre-determined or self-tuned.

For the purpose of illustration only, the input and output signals of the systems can be electrical signals or digital signals, or computer simulated electrical signals or digital signals. Also for the purpose of illustration only, each artificial neuron of the systems can be electrical circuits, electrically-simulated neurons, or computer-simulated neurons.

The devices disclosed in this disclosure can be hardware-based or software-based. In one aspect, the device is a physical neuron network liquid state machine. In another aspect, the device is implemented on a semiconductor chip. In yet another aspect, the device is a computer-simulated neuron network liquid state machine or semiconductor chip.

Also provided is a method for tuning a network of artificial neurons interconnected by connections, wherein each artificial neuron is configured to receive an input signal from and send an output signal to one or more of the other artificial neurons through one of the connections, comprising:

generating an activation for each artificial neuron at a time point based on:

1) input signals received by the artificial neuron;

2) output signals sent from the artificial neuron; and

3) a plurality of weights, wherein at least one weight is self-tuned at the time point.

Also provided is a non-transitory computer readable storage medium including one or more instructions executable by a processor for implementing a self-tuned neural network, wherein the self-tuned neural network comprises a plurality of artificial neurons interconnected by connections, the non-transitory computer readable storage medium comprising one or more instructions for:

each artificial neuron receiving an input signal from and sending an output signal to one or more of the other artificial neurons through one of the connections, wherein each input and output signal is positive or negative valued; and

each artificial neuron having an activation at a time point, the activation being determined by at least input signals received by the artificial neuron, output signals sent by the artificial neuron, and a plurality of weights, wherein at least one weight is self-tuned at the time point.

### BRIEF DESCRIPTION OF THE DRAWINGS

Provided embodiments are illustrated by way of example, and not limitation, in the figures of the accompanying drawings in which:

FIG. 1A shows a neural network with a recurrent lattice connectivity pattern;

FIG. 1B shows a neural network with a random binary tree connectivity pattern;

FIG. 2 shows moving average estimates of the critical branching parameter α over the course of tuning for two different values of ω;

FIG. 3 shows classifier performance as a function of τ for the three different classification tasks;

FIG. 4 shows classifier performance (averaged over τ) as a function of distance from critical branching;

FIG. 5 shows performance for each of classification task plotted as a function of total number of model neurons in the network;

FIG. 6 shows that lattice connectivity was best for the XOR and parity functions; whereas type of connectivity did not affect noisy pattern classification;

FIG. 7 shows an exemplary computer system suitable for use with the present disclosure;

FIG. 8 shows an exemplary neuron circuit suitable for use with the present disclosure;

FIG. 9 shows instantaneous estimates of the critical branching exponent plotted for each time step of simulation;

FIG. 10 is a histogram of neural avalanche sizes, plotted in log-log coordinates;

FIG. 11A-B show liquid state fading memory capacity (τ) for three different functions: XOR, 3-bit parity, and n-bit parity classification;

FIG. 12 shows liquid state performance for the three different classification tasks (XOR, 3-bit parity, and n-bit parity) plotted as a function of estimated σ;

FIG. 13 shows liquid state performance in terms of MC for the three different classification tasks (XOR, 3-bit parity, and n-bit parity) plotted as a function of number of neurons per LSM layer; and,

FIG. 14 shows liquid state performance for the three different classification tasks (XOR, 3-bit parity, and n-bit parity) plotted in terms of MC as a function of the number of postsynaptic connections (m) on the input layer (2m on the LSM and output layers).

It will be recognized that some or all of the figures are schematic representations for purposes of illustration and do not necessarily depict the actual relative sizes or locations of the elements shown. The figures are provided for the purpose of illustrating one or more embodiments with the explicit understanding that they will not be used to limit the scope or the meaning of the claims.

### DETAILED DESCRIPTION OF THE DISCLOSURE

As used herein, certain terms have the following defined meanings Terms that are not defined have their art recognized meanings

As used in the specification and claims, the singular form “a”, “an” and “the” include plural references unless the context clearly dictates otherwise.

As used herein, the term “comprising” is intended to mean that the compositions and methods include the recited elements, but not excluding others. “Consisting essentially of” when used to define compositions and methods, shall mean excluding other elements that would materially affect the basic and novel characteristics of the technology. “Consisting of” shall mean excluding any element, step, or ingredient not specified in the claim. Embodiments defined by each of these transition terms are within the scope of this disclosure.

In some embodiments an “artificial neuron”, a “simulated neuron”, or simply a “neuron” refers to a device or a simulated device that implements a mathematical function. In various embodiments, it is conceived as a crude model, or abstraction of biological neurons. Artificial neurons, in some embodiments, are the constitutive units in an artificial neural network. An artificial neuron can receive one or more inputs and sum them to produce an output, which is also known as a “synapse”. In one aspect, the sums of each input are weighted, and the sum is passed through a non-linear function known as an activation function or transfer function.

Embodiments of an “artificial neural network” or simply a “neural network” include a device or a simulated device that implements a mathematical model or computational model. In one embodiment, a neural network tries to simulate the structure and/or functional aspects of biological neural networks. An artificial neural network can consist of an interconnected group of artificial neurons and processes information using a connectionist approach to computation. In some embodiments an artificial neural network is an adaptive system that changes its structure based on external or internal information that flows through the network during the learning phase.

Artificial neurons and artificial neural networks and can be hardware-based or software-based. Non-limiting examples of hardware-based artificial neurons and artificial neural networks include a physical neural network liquid state machine utilizing nanotechnology as disclosed in U.S. Pat. No. 7,392,230, a neural semiconductor chip and neural networks incorporated therein as disclosed in U.S. Pat. No. 5,717,832, and a neural network accommodating parallel synaptic weight adjustments for correlation learning algorithms as disclosed in U.S. Pat. No. 5,237,210, all of which are incorporated by reference in their entirety.

A “connection” between two discrete points allows the flow or transfer of a signal from one point to the other. In one aspect, a connection is a unidirectional connection which allows flow or transfer of a signal from one point to the other. In another aspect, a connection is a bidirectional connection which allows flow or transfer of a signal from one point to other or the other way around. In some embodiments, the signal is an electron or an electrical signal. In some embodiments, the signal is a digital signal.

An “activation” of an artificial neuron refers to the sum of the inputs received by the neuron. In one aspect, the sums of each input are weighted and the sum is determined by an activation function.

A “spike” in some embodiments is a non-zero output sent by an artificial neuron to one or more other artificial neurons. In one aspect, the size of the spike and whether or not an artificial neuron fires a spick at a time point are determined by an output function. In one aspect, a spike is positive-valued. In another aspect, a spike is negative-valued. In yet another aspect, a spike is either positive- or negative-valued.

Some embodiments of “self-tuning” refer to a parameter being adjusted based on inputs and feedbacks rather than being predetermined. In one aspect, the parameter is adjusted to optimize the performance of a system. In another aspect, the parameter is adjusted to adapt to a new condition. In yet another aspect, the parameter is a weight associated with an input to an artificial neuron and it is adjusted based on inputs and outputs of the artificial neuron.

Some embodiments of a “liquid state machine” are computational systems, like a neural networks. A liquid state machine can take external inputs over time and holds their information in a dynamic “reservoir” memory. A liquid state machine can consist of a large collection of units (called nodes, or neurons). In one embodiment, each node receives time varying input from external sources (the inputs) as well as from other nodes. Nodes are randomly connected to each other. The recurrent nature of the connections turns the time varying input into a spatio-temporal pattern of activations in the network nodes. The spatio-temporal patterns of activation are read out by linear discriminant units. The soup of recurrently connected nodes will end up computing a large variety of nonlinear functions on the input. Given a large enough variety of such nonlinear functions, it is theoretically possible to obtain linear combinations (using the read out units) to perform whatever mathematical operation is needed to perform a certain task, such as speech recognition or computer vision. An exemplary liquid state machine is disclosed in U.S. Pat. No. 7,392,230 which is incorporated by reference in its entirety.

A “processor” is an electronic circuit that can execute computer programs. Examples of processors include, but are not limited to, central processing units, microprocessors, graphics processing units, physics processing units, digital signal processors, network processors, front end processors, coprocessors, data processors and audio processors.

A “memory” refers to an electrical device that stores data for retrieval. In one aspect, a memory is a computer unit that preserves data and assists computation.

Biological neurons in brains give rise to cognitive functions (like perception, classification, memory, and attention) by virtue of their computational properties. Current theories of neural computation emphasize the action potential, which is a discrete, electrical signal that travels the axon of a neuronal cell. Action potentials make contact with other connected neurons via synapses. Signals are processed at synapses resulting in further spikes being produced along pathways of connected neurons. Spike-based models simulate memory and other cognitive functions in terms of changes to synaptic connections and their effects on spikes. The present technology uses both positive-valued and negative-valued spikes, combined with critical branching, to formulate a novel architecture for neural-like computation.

From a computational point of view, neurons in brains give rise to cognitive functions (like perception, classification, memory, and attention) by virtue of their computational properties. Current theories of neural computation emphasize the action potential, which is a discrete, electrical signal that travels the axon of a neuronal cell. Action potentials make contact with other connected neurons via synapses. Signals are processed at synapses resulting in further spikes being produced along pathways of connected neurons. Spike-based models simulate memory and other cognitive functions in terms of changes to synaptic connections and their effects on spikes. The current technology uses the novel concept of both positive-valued and negative-valued spikes, combined with critical branching, to formulate a novel architecture for neural-like computation.

One embodiment of the disclosure comprises a set of equations describing a formal model of spike-based, neural-like memory and computation. The equations can be implemented simply in computer hardware and software, and only require local information with respect to each individual neuron and its post-synaptic connections. Information can be coded as spiking patterns generated by simulated neurons, and simulated neural networks can take informational inputs in the form of spiking patterns. Simulated networks can process and hold information in the form of dynamic spike patterns. The amount of information that can be held over time (informational capacity) can be maximal when spikes follow a critical branching process, i.e., exactly one subsequent spike is expected to follow each preceding spike. A local synaptic weight tuning algorithm is designed to gradually guide spiking dynamics towards critical branching. Both positive-valued and negative-valued spike events are used so that the tuning algorithm stabilizes network dynamics while preserving and processing information over time. The resulting simulated neural network is able to integrate and hold information over time, and expand the representation of information so that non-linearly separable input patterns become linearly separable. These properties of information processing constitute a new kind of liquid state machine that can become useful in future computer circuit designs inspired by neural circuitry.

### I. Self-Tuning Artificial Neural Networks

The present disclosure, in one embodiment, provides a system, comprising, or alternatively consisting essentially of, or alternatively consisting of, a network of artificial neurons interconnected by connections, wherein:

each artificial neuron is configured to receive an input signal from and send an output signal to one or more of the other artificial neurons through one of the connections;

each input and output signal is either positive or negative valued; and

each artificial neuron has an activation at a time point, the activation being determined by at least input signals received by the artificial neuron, output signals sent by the artificial neuron, and a plurality of weights, wherein at least one weight is self-tuned at the time point.

Also provided is a computational system, comprising, or alternatively consisting essentially of, or alternatively consisting of:

a processor;

a memory coupled to the processor; computer code, loaded into the memory for execution on the processor, for implementing an artificial neural network, the artificial neural network having a plurality of artificial neurons interconnected by connections, wherein:

each neuron is configured to receive an input signal from and send an output signal to one or more of the other artificial neurons through one of the connections;

each input and output signal is either positive or negative valued; and

each artificial neuron has an activation at a time point, the activation being determined by at least input signals received by the neuron, output signals sent by the neuron, and a plurality of weights, wherein at least one weight is self-tuned at the time point.

In one aspect, the systems of this technology further comprise an external signal device connected to the network of artificial neurons, wherein one or more artificial neurons is configured to receive an input signal from the external signal device. The external device can be any devices that can produce and emit a signal, such as, but not limited to, memories including computer memories, scanners including image readers, microphones or other types of audio signal generators, and video receivers.

Devices provided in some embodiments can further comprise an external signal device and an external receiving device for the neural network to communicate with the external environment. For example, the neural network provided in some embodiments of this disclosure can be implemented as a semiconductor chip, such as a central processing unit of a computer. Accordingly, the external signal device and the external receiving device can be the main memory of the computer that sends input data to the processing unit and receives output data from it.

In another aspect, the systems of this disclosure further comprise an external receiving device an external receiving device connected to the network of artificial neurons, wherein one or more artificial neurons sends an output signal to the external receiving device. The external receiving device can be any device that is configured to receive a signal, such as, but not limited to, memories such as computer memories, monitors including any form of digital or analog graphics display devices, and speakers.

In another aspect, each artificial neuron further receives a noise signal either from an external source or generated within the artificial neuron. The noise signal can be a signal perturbation natural to a physical or a simulated device.

In yet another aspect, the systems of this disclosure further comprise a control unit with a connection to each artificial neuron. The control unit is configured to receive a data signal from one or more artificial neurons, conduct computation, including computations based on the tuning methods provided herein, and send a command signal back to the artificial neurons. A data signal or a command signal can be any signal that the artificial neurons receive or send. Because the tuning algorithm provided in the current disclosure can be based on only local information, the methods can be carried out within each individual neuron, thus the control unit is not a required component of the system. But in some embodiments, a control unit is provided and it can assist with local or non-local computation.

In some embodiments, the input signals determining the activation of the artificial neuron are input signals received by the artificial neuron at a prior time point preceding the time point at which the activation is determined. In some embodiments, the output signals determining the activation of the artificial neuron are output signals sent by the artificial neuron at a prior time point preceding the time point at which the activation is determined. However, the tuning algorithm can be applied to continuous time and/or asynchronous updating.

In one aspect, each connection is a unidirectional connection.

In one aspect, each weight is independently self-tuned. The weights can be self-tuned at a time point so that a non-zero output signal sent by each artificial neuron is followed by one non-zero output signal among all artificial neurons to which the artificial neuron sends an output signal. In some embodiments, the non-zero output signal is a spike.

In some embodiment, the activation of an artificial neuron is locally determined. Accordingly, the activation of each artificial neuron is not directly based on the activation of other artificial neurons or input or output signals not received or sent by the artificial neuron. Therefore, computation of activation, input signals, output signals, or weights can be conducted with information obtained within the artificial neuron, and conducted within the artificial neuron.

In one aspect, the activation of each artificial neuron is determined according to Equation (1):

$${I}_{j} ( t + 1 ) = - {s}_{j} ( t ) + {I}_{j} ( t ) + {E}_{j} ( t ) + {\sum }_{i = 1}^{{pre}_{j}} {w}_{ij} ( t ) {s}_{i} ( t ) \qquad ( 1 )$$

wherein:

Iⱼ(t+1) is the activation for artificial neuron j at time t+1;

sⱼ(t) is the output signal of artificial neuron j at time t;

Eⱼ(t) is an optional external input signal to artificial neuron j at time t;

sᵢ(t) is the output signal of artificial neuron i at time t;

wᵢⱼ(t) is the weight associated with sᵢ(t) at time t; and

preⱼ indexes the artificial neurons that send output signals to artificial neuron j.

In some embodiments, output signal sent by each artificial neuron can be determined by at least the activation of the artificial neuron and a threshold parameter. The threshold parameter can be pre-determined or self-tuned. In some embodiments, the output signal is determined according to Equation (2):

$${s}_{j} ( t + 1 ) = \{ \begin{matrix}θ , & {I}_{j} ( t ) \geq θ \\ - θ , & {I}_{j} ( t ) \leq - θ \\ 0 , & - θ < {I}_{j} ( t ) < θ\end{matrix} \qquad ( 2 )$$

wherein:

sⱼ(t+1) is the output signal of artificial neuron j at time t+1;

Iⱼ(t) is the activation of artificial neuron j at time t; and

θ is the threshold parameter.

θ is a threshold parameter that can be set arbitrarily with respect to weight values because in some embodiments of the disclosure, the weights are adjusted in accordance with θ. Accordingly, θ should be set with respect to the noise and external input signals. In one aspect, θ is approximately equal to max E to ensure that perturbations from external input signals or noise have moderate effects. In one aspect, E also includes noise signals, ε, either received by the artificial neuron, or generated within the artificial neuron. Relative higher values of θ increasingly diminish the effects of perturbations on spikes, and relatively lower values cause increasingly longer bursts of spikes in response to perturbations.

In one aspect, each weight is determined according to Equation (3):

$${w}_{ij} ( t + 1 ) = {w}_{ij} ( t ) + sgn ( {w}_{ij} ( t ) ) \times \{ \begin{matrix}β , & {N}_{i} ( t + 1 ) = 0 \\ 0 , & {N}_{i} ( t + 1 ) = 1 \\ - β , & {N}_{i} ( t + 1 ) > 1\end{matrix} \qquad ( 3 )$$

wherein:
wᵢⱼ(t+1) is the weight associated with sᵢ(t+1) at time t+1;
wᵢⱼ(t) is the weight associated with sᵢ(t) at time t;
sgn( ) is a signum function;
β is a weight change parameter; and
Ni(t+1) is determined according to Equation (4):

$${N}_{i} ( t + 1 ) = {\sum }_{j = 1}^{{post}_{i}} \{ \begin{matrix}1 , & {s}_{i} ( t ) \times sgn ( {w}_{ij} ( t ) ) = {s}_{j} ( t + 1 ) \\ 0 , & {s}_{i} ( t ) \times sgn ( {w}_{ij} ( t ) ) \neq {s}_{j} ( t + 1 )\end{matrix} \qquad ( 4 )$$

wherein:

postᵢ indexes the artificial neurons that artificial neuron i sends an output signal to;

sᵢ(t) is the output signal of artificial neuron i; and

sⱼ(t+1) is the output signal of artificial neuron j.

In one aspect, each weight is determined according to Equations (3) and (4), with the proviso that when sᵢ(t)=sᵢ(t−1)≠0, then the weight is determined according to Equation (5):

$${w}_{ij} ( t + 1 ) = {w}_{ij} ( t ) - γ \times sgn ( {w}_{ij} ( t ) ) \times \{ \begin{matrix}1 , & {s}_{j} ( t ) {s}_{j} ( t + 1 ) = {θ}^{2} \\ 0 , & {s}_{j} ( t ) {s}_{j} ( t + 1 ) \neq {θ}^{2}\end{matrix} \qquad ( 5 )$$

wherein:

γ is a weight change parameter;

θ is a threshold parameter;

wᵢⱼ(t+1) is the weight associated with sᵢ(t+1) at time t+1;

wᵢⱼ(t) is the weight associated with sᵢ(t) at time t;

sⱼ(t) is the output signal of artificial neuron j at time t;

sⱼ(t+1) is the output signal of artificial neuron j at time t+1; and

sgn( ) is a signum function.

Alternatively, at each time step t, the membrane potential of every neuron can be determined from the weighted sum of spikes from presynaptic neurons, as well as from external inputs, according to the equation

v^{t+1}=δ[v^{t}∘(1−s^{t})+ε^{t}+(W^{t}−ζI)s^{t}] (6)

where ∘ denotes the Hadamard product (i.e., element-wise multiplication). The notation 1 denotes the column vector of ones. Each term represents:

δ: the leak time constant, which in some embodiments is 0.9;

v^{t}: the membrane potentials of neurons at time t;

ε^{t}: external input/perturbation to v^{t};

W^{t}: the weight matrix between neurons;

ζ: an analogue of the refractory period, which in some embodiments is 1.0;

I: the identity matrix;

s^{t}: the Boolean vector denoting spikes in v^{t}, i.e.,

s^{t}\dot{=}[v^{t}≧1].

using Iverson notation for a Boolean condition.

Determination activation, computation of weights, or other computations including, but not limited to Equations (1) to (5), can be conducted within each individual artificial neuron. Alternatively, in some embodiments, information required for the computation is collected by a control unit, the computation is conducted in the control unit, and the outcome is then sent from the control unit back to the artificial neuron.

For the purpose of illustration only, the input and output signals of the systems can be electrical signals or digital signals, or computer simulated electrical signals or digital signals. Also for the purpose of illustration only, each artificial neuron of the systems can be electrical circuits, electrically-simulated neurons, or computer-simulated neurons.

The artificial neuron network provided in some embodiments can be implemented on any hardware or software-based system, and is not limited by any specific technology. For the purpose of illustration only, in some embodiments, the network of artificial neurons is a physical neuron network liquid state machine. In some embodiments, the network of artificial neurons is implemented on a semiconductor chip. Semiconductor chips, also known as silicon chips, microcircuits, microchips, or integrated circuits are known in the art. In some embodiments, the network of artificial neurons is implemented on microstructure circuit utilizing nanotechnology, phase change memory, magnetic tunnel junctions, organic nanotraps, and nickel oxide. A non-limiting example of a circuit utilizing nanotechnology is a nanocircuit as disclosed in U.S. Pat. No. 7,026,247, which is incorporated by reference in its entirety.

Further provided is a non-transitory computer readable storage medium including one or more instructions executable by a processor for implementing a self-tuned neural network, wherein the self-tuned neural network comprises a plurality of artificial neurons interconnected by connections, the computer readable storage medium comprising one or more instructions for:

each artificial neuron receiving an input signal from and sending an output signal to one or more of the other artificial neurons through one of the connections, wherein each input and output signal is positive or negative valued; and

each artificial neuron having an activation at a time point, the activation being determined by at least input signals received by the artificial neuron, output signals sent by the artificial neuron, and a plurality of weights, wherein at least one weight is self-tuned at the time point.

Non-limiting examples of non-transitory computer readable storage medium include CD-ROM, DVD, Blue Ray DVD, Tape Drive and memory stick.

### II. Neuron Circuits

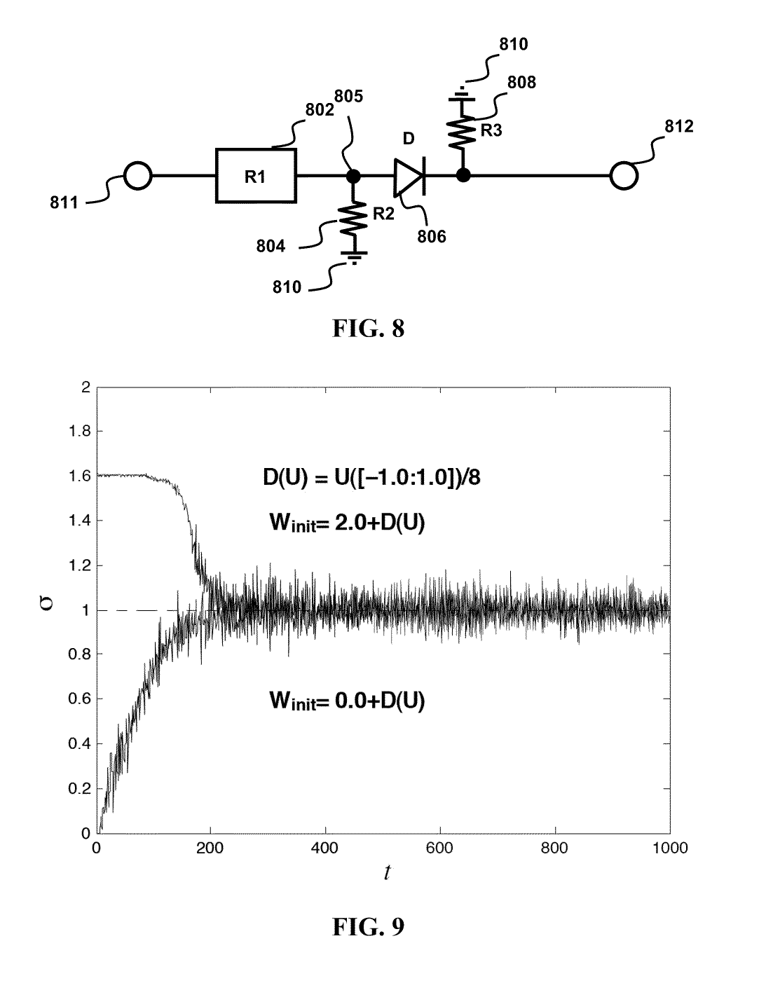

An artificial neuron can be implemented as a diode-based circuit as illustrated in FIG. 8. The diode can be a basic semiconductor electrical unit. The signal it sums can be a voltage. It is known in the art that other devices and components can be utilized instead of a diode to construct a physical neural network and a neuron-like node.

FIG. 8 illustrates a neuron circuit that comprises a neuron-like node that may include a diode 806 (D), and a resistor 804 (R2). Resistor 804 is connected to a ground 810 and an input 805 of diode 206. A resistor 802, which is represented as a block (R1), can be connected to input 805 of diode 806. Block 802 includes an input 811, which comprises an input to the neuron. A resistor 808 (R3) is also connected to an output 812 of diode 806. Additionally, resistor 808 is coupled to ground 810. Diode 806 in a physical neural network is analogous to a neuron of a human brain, while an associated connection formed thereof, is analogous to a synapse of a human brain.

As known to persons of ordinary skill in the art, artificial neurons having configurations or architectures other than that illustrated in FIG. 8 can be used with embodiments of the present disclosure.

### III. Computer Systems

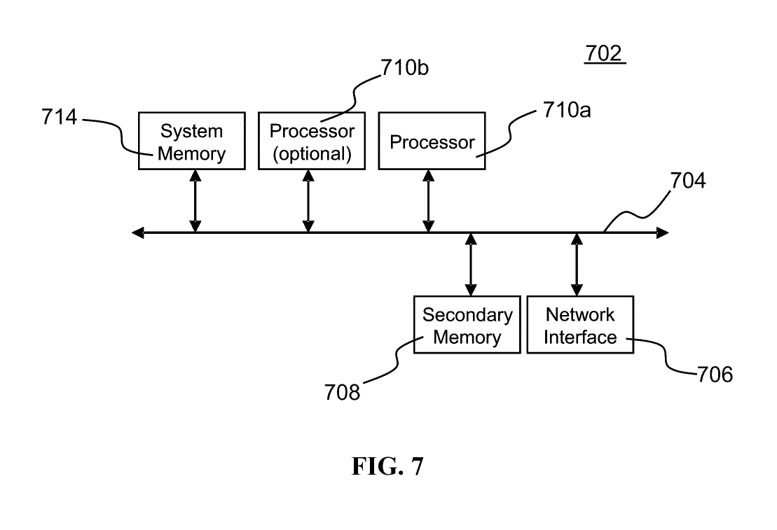

FIG. 7 illustrates an example of a computational system 702 on which the neural network can be implemented. The computer system 702 can include one or more processor(s) 710a, 710b. Processor(s) 710 are connected to a transmission infrastructure 704, such as an internal bus or network. The computer system 702 also includes system memory (or random access memory (RAM)) 714, and can include a secondary memory 708. Secondary memory 708 can include a hard disk drive (not illustrated) and/or a removable storage drive (not illustrated), such as a magnetic tape drive, an optical disk drive, etc. The removable storage drive can read from and/or write to a removable storage medium/computer readable storage medium, such as magnetic tape, optical disk, magneto-optical disk, removable memory chip (or card), or any other storage medium that allows software and/or data to be loaded into computer system 702 via the removable storage drive. The computer system 702 shown in FIG. 7 can further include one or more network interfaces 706 that allow software and/or data to be transferred between computer system 702 and external devices (not shown). Examples of network interfaces 706 include modems, Ethernet cards, etc.

Like processor(s) 710, system memory 714, secondary memory 708, and network interface 706 each also connect to transmission infrastructure 704. The use of transmission infrastructure 704 allows software and/or data transmission among processor(s) 710, system memory 714, secondary memory 708, and network interface 706. Software and/or data transmitted via transmission infrastructure 704 or network interface 706 can be in the form of signals such as electronic signals, electromagnetic signals, optical signals, or any other form that facilitates the transmission of data.

Any suitable programming language can be used to implement the software routines or modules that can be used with embodiments of the present disclosure. Such programming languages can include C, C++, Java, assembly language, etc. Procedural and object oriented programming techniques can also be used with the present disclosure. The software routines or modules can be stored in system memory 714 and/or secondary memory 708 for execution by one or more processor(s) 710 to implement embodiments of the present disclosure.

As known to persons of ordinary skill in the art, computer systems having configurations or architectures other than that illustrated in FIG. 7 can be used with embodiments of the present disclosure. For example, a standalone computer system need not include network interface 706, and so on.

### IV. Methods of Self-tuning an Artificial Neural Network

The disclosure also provides a method for tuning a network of artificial neurons interconnected by connections, wherein each artificial neuron is configured to receive an input signal from and send an output signal to one or more of the other artificial neurons through one of the connections, comprising:

generating an activation for each artificial neuron at a time point based on:

1) input signals received by the artificial neuron;

2) output signals sent from the artificial neuron; and

3) a plurality of weights, wherein at least one weight is self-tuned at the time point.

In one aspect of the method, each input signal received by the artificial neuron and each output signal sent from the artificial neuron is either positive or negative valued.

In some embodiments, the input signals determining the activation of the artificial neuron are input signals received by the artificial neuron at a prior time point preceding the time point at which the activation is determined. In some embodiments, the output signals determining the activation of the artificial neuron are output signals sent by the artificial neuron at a prior time point preceding the time point at which the activation is determined. However, the tuning algorithm can be applied to continuous time and/or asynchronous updating.

In one aspect, the activation is further based on a noise signal received either from an external source or generated within the artificial neuron.

In one aspect, each weight is independently self-tuned. In another aspect, the weights are self-tuned at a time point so that a non-zero output signal sent by each artificial neuron is followed by one non-zero output signal among all artificial neurons to which the artificial neuron sends an output signal. In a particular aspect, the non-zero output signal is a spike.

In some embodiments, the activation of an artificial neuron is based on an algorithm according to Equation (1) as previously defined.

In one aspect, the output signal sent by each artificial neuron can be at least based upon the activation of the artificial neuron and a threshold parameter. The threshold parameter can be either pre-determined or self-tuned. In some embodiments, the output signal is determined according to Equation (2) as previously defined.

One aspect of the disclosure provides that the weights are determined according to Equations (3) and (4) as previously defined.

For the purpose of illustration only, the input and output signals of the method can be electrical signals or digital signals, or computer simulated electrical signals or digital signals. Also for the purpose of illustration only, each artificial neuron of the method can be electrical circuits, electrically-simulated neurons, or computer-simulated neurons.

The Appendix contains exemplary source code listings for a series of programs that have been implemented to simulate a lattice neural network in which a self-tuning algorithm is provided, and to demonstrate maximizing memory capacity, according to embodiments of the current disclosure. As known in to persons of ordinary skill in the art, software code/modules other than that provided in the Appendix can be used with embodiments of the current disclosure. Included in the Appendix are two sections which are organized as follows:

Section A, beginning at page 1, includes a C program source code to simulate the noisy pattern classification computation.

Section B, beginning at page 6, includes a C program source code to simulate the XOR and parity pattern classification computations.

The following examples are provided to illustrate certain aspects of the present disclosure and to aid those of skill in the art in practicing the disclosure. These examples are in no way to be considered to limit the scope of the disclosure.

### EXAMPLES

### Example 1

This example presents a neural network model that produces computationally useful spiking dynamics. Spikes are dynamically excitatory or inhibitory, and the model includes one local algorithm that tunes connection weights towards critical branching, and another that tunes away from spike saturation. Classification of input signals from perturbations of spiking dynamics showed that lattice connectivity supported memory and separation of inputs.

### 1. Neural Networks

Nervous systems tend to be characterized by recurrent loops across a wide range of spatial and temporal scales. In particular, if one traces the branching of synaptic connections projecting out from a given starting neuron, numerous branches can be found to recurrently connect back to the starting neuron. These recurrent loops may consist of a wide range of intervening numbers of neurons, and intervening neurons may range from physically proximal to distal with respect to the starting neuron.

Spiking dynamics are thresholded and thus inherently nonlinear. When spiking dynamics are instantiated in recurrent loops of various scales, the resulting collective activity is often associated with chaotic dynamics, and considered to be complex in this regard. Model systems have been proven to be chaotic, and real nervous systems have been observed to exhibit signatures of chaotic dynamics, e.g. in terms of Lyapunov exponents and information theoretic measures of collective neural activity.

Evidence for near-chaotic neural dynamics has led researchers to consider whether this property of complexity might be important for neural information transmission and processing, rather than just a byproduct of nonlinearities and recurrent loops. One possibility is that complexity is essential to producing metastable, responsive spiking dynamics. Neural networks at all scales (from microcircuits to subcortical and cortical structures to whole brains) must produce spiking dynamics that are mutable in response to external inputs, where external inputs may originate from outside an organism via sensory systems, or from other neural or physiological systems within an organism. Unresponsive dynamics would not support the transmission and processing of information. However, overly responsive dynamics would also be problematic because neural activity may spread like wildfire through the system, causing neurons to saturate and hence lose their informational capacity.

1.1 Critical Branching

A balance can be struck between unresponsive and overly responsive spiking by relating their dynamics to a critical branching process. Critical branching processes describe the occurrence of discrete, generic events over time, where each “ancestor” event may cause some number of subsequent “descendant” events, and descendants may become ancestors to subsequent events over time. The expected number of descendant events is described by α, and for critical branching α=1. Spikes are the events in this case, and external inputs can be described as ancestor spikes that cause descendant spikes in a given neural system. If α<1, the number of spikes will diminish over time, and information will not be transmitted throughout the system in terms of spike dynamics. If α>1, spikes will grow over time, and eventually come to saturate the network. Critical branching describes the point at which spikes are conserved over time, and can thus propagate throughout the system without dying out and without running rampant.

Electrophysiological recordings of neural activity, both in vitro and in vivo, have provided evidence for critical branching dynamics. Probabilistic models of critical branching have been shown to simulate distributions of recorded neural activity, but these models were abstracted away from membrane potentials, action potentials, and synaptic connections. Thus they cannot serve as mechanistic models of neural computation.

### 1.2 Criticality and Liquid State Machines

Critical branching processes are potentially useful for regulating neural spiking dynamics, but current critical branching models are not amenable to neural computation. However, critical branching is one kind of model of criticality, and other such models have been shown to support computation. Criticality refers to phenomena observed near phase transitions in systems described by statistical mechanics. In particular, transitions between ordered (regular) and disordered (chaotic) phases have been associated with computational capacity.

“Edge of chaos” computing has been simulated in terms of liquid state machines. Liquid state machines use recurrent loops and nonlinear neurons to create dynamical activity that can be perturbed with external inputs. Loops are created using random synaptic connectivity, the rationale being that random connectivity captures relevant characteristics of real neural networks. A separate “readout” function, such as a linear classifier, is trained to extract information about previous external inputs from current, instantaneous activities. Analyses and simulation results have shown that dynamics in liquid state machines play the role of kernel functions in support vector machines, thereby making nonlinear input classifications linearly separable.

In addition to random connectivity, liquid state machines are also typically designed with weights on synaptic connections chosen a priori in order to produce computationally useful, general-purpose dynamics. Weights are not adapted to learn, e.g., input statistics or input-output mappings.

### 2. Self-Tuned, Critical Branching Neural Network Model

The embodiments of the present disclosure provide a model that simulates neural computation near criticality, but in a network of spiking neurons instead of threshold gates. The model includes two complementary tuning algorithms that are local in time and space. One is a post-synaptic renormalization algorithm that tunes post-synaptic weights towards critical branching, and the other is a pre-synaptic renormalization algorithm that tunes neurons away from saturation. The algorithms only require local knowledge of spike timing.

### 2.1 Integrate-and-Fire Neurons

Each model neuron summed inputs from other neurons, and from external inputs, according to Equation (1):

$${I}_{j} ( t + 1 ) = - {s}_{j} ( t ) + {I}_{j} ( t ) + {E}_{j} ( t ) + {\sum }_{i = 1}^{{pre}_{j}} {w}_{ij} ( t ) {s}_{i} ( t ) \qquad ( 1 )$$

where Iⱼ(t+1) is the summed input for neuron j at time t+1,
sⱼ(t) is the output state of neuron j at time t,
Eⱼ is external input to neuron j,
wᵢⱼ is the connection weight from pre- to post-synaptic neurons i to j, and
preⱼ is the number of connections feeding into neuron j.

The −sⱼ(t) term removes the output value from a given neuron's summed input when it spikes. Summed inputs can be positive or negative real numbers, which means that positive and negative inputs may cancel out each other when summed. This cancellation creates a dynamic leak in the model's total input magnitude, Σ|Iⱼ|. Outputs are calculated according to Equation (2):

$${s}_{j} ( t + 1 ) = \{ \begin{matrix}θ , & {I}_{j} ( t ) \geq θ \\ - θ , & {I}_{j} ( t ) \leq - θ \\ 0 , & - θ < {I}_{j} ( t ) < θ\end{matrix} \qquad ( 2 )$$

where θ=1 for the current models. θ is a threshold parameter that can be set arbitrarily with respect to weight values because the tuning algorithms will adjust weight magnitudes in accordance with θ. In addition to the dynamic leak, positive and negative thresholds (i.e. spikes) are used so that |Iⱼ| is linearly related to Pr(sⱼ≠0). This linear relation facilitates the tuning algorithms described next.

### 2.2 Complementary Tuning Algorithms

The tuning algorithms were designed to scale (renormalize) post-synaptic and pre-synaptic connection weights, respectively. The post-synaptic algorithm scales weights so that a given spike on neuron i produced at time t is expected to be followed at t+1 by exactly one corresponding spike over its post-synaptic neurons. So, if sᵢ(t)≠0 for neuron i, apply Equation (3) at t+1 for all its post-synaptic weights wᵢⱼ(if sᵢ(t)=0, there is no pre-synaptic spike, so no reason to adjust post-synaptic weights with respect to critical branching):

$${w}_{ij} ( t + 1 ) = {w}_{ij} ( t ) + sgn ( {w}_{ij} ( t ) ) \times \{ \begin{matrix}β , & {N}_{i} ( t + 1 ) = 0 \\ 0 , & {N}_{i} ( t + 1 ) = 1 \\ - β , & {N}_{i} ( t + 1 ) > 1\end{matrix} \qquad ( 3 )$$

where sgn( ) is the signum function, β is a weight change parameter, and Nᵢ(t+1) is the number of post-synaptic neurons that produced a spike with respect to sᵢ(t) at time t+1. This number is given by Equation (4):

$${N}_{i} ( t + 1 ) = {\sum }_{j = 1}^{{post}_{i}} \{ \begin{matrix}1 , & {s}_{i} ( t ) \times sgn ( {w}_{ij} ( t ) ) = {s}_{j} ( t + 1 ) \\ 0 , & {s}_{i} ( t ) \times sgn ( {w}_{ij} ( t ) ) \neq {s}_{j} ( t + 1 )\end{matrix} \qquad ( 4 )$$

where postᵢ is the number of connections feeding out from neuron i.

In preliminary simulations, the post-synaptic algorithm achieved critical branching under all input and connectivity conditions examined. However, the computational capacity of the model was sometimes compromised by saturated neurons. Depending on connectivity and amount of external input, self-sustaining recurrent loops would sometimes emerge and cause neurons in the loop to fire continuously (note the lack of a refractory period).

To reduce saturation, the pre-synaptic tuning algorithm shrinks weights on incoming connections to neurons that fire two of the same spikes at adjacent points in time according to Equation (5):

$${w}_{ij} ( t + 1 ) = {w}_{ij} ( t ) - γ \times sgn ( {w}_{ij} ( t ) ) \times \{ \begin{matrix}1 , & {s}_{j} ( t ) {s}_{j} ( t + 1 ) = {θ}^{2} \\ 0 , & {s}_{j} ( t ) {s}_{j} ( t + 1 ) \neq {θ}^{2}\end{matrix} \qquad ( 5 )$$

where γ is a weight change parameter and θ is the threshold parameter, and is 1 in this experiment. Exploration of the two tuning parameters indicated generally good performance when β<<θ, γ<<θ, and γ<β. In all simulations to follow, β=0.01 and γ=0.005. Both tuning algorithms scale weights uniformly across incoming and outgoing connections. Therefore they may co-exist with other mechanisms such as Hebbian learning or synaptic timing dependent plasticity.

### 2.3 Synaptic Connectivity, Tuning, and Stability

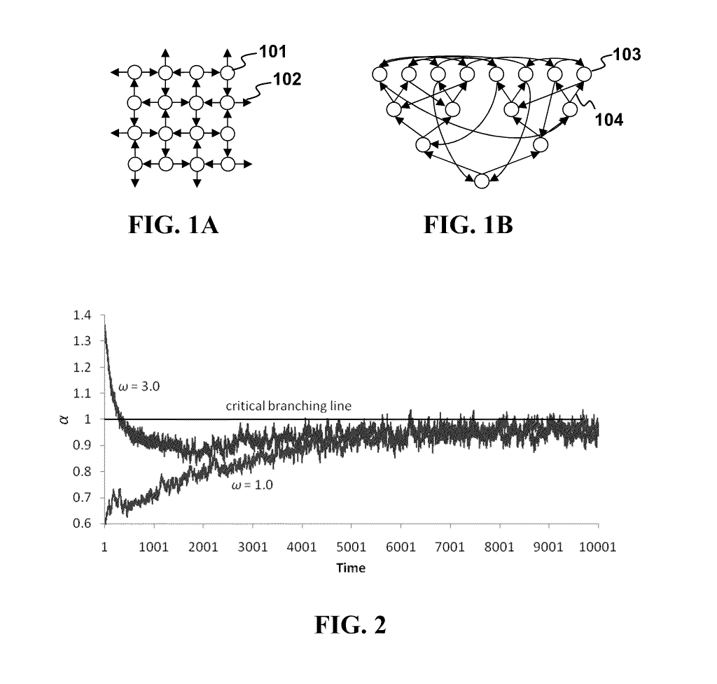

The tuning algorithms should, in principle, work with any given synaptic connectivity. However, they have the greatest degrees of freedom when the number of incoming (Kᵢₙ) and outgoing (Kₒᵤₜ) weights per neuron is minimized. Therefore Kᵢₙ=2 and Kₒᵤₜ=2 in the current models, as shown in FIGS. 1A and 1B (edge connections represent periodic boundary conditions).

FIG. 1A illustrates a network architecture with 32×32 lattices of neurons. Each circle 101 represents a neuron. Each edge 102 represents a connection, or synaptic connection. The arrow indicates the connection is unidirectional. A lattice network is composed of four branches connected in series to form a mesh; two nonadjacent junction points serve as input connections, and the remaining two junction points serve as output connections.

FIG. 1B illustrates a network architecture with a binary tree. Each circle 103 represents a neuron, and each edge 104 represents a synaptic connection. Like in FIG. 1A, the arrows indicate the direction of the connection. Synaptic connections feed forward from bottom to top, and recurrent connections feed from the top layer back onto itself, and back onto the layers below.

In both lattice and binary tree architectures, recurrent connections are random, but constrained such that there are exactly two pre-synaptic connections and two post-synaptic connections per neuron. The architecture can be extended ad infinitum by doubling each additional layer. Note that the disclosure encompasses any pattern of connectivity; the recurrent binary tree network is used here because it is apt for minimizing the number of postsynaptic connections, and illustrating the model's liquid state machine properties.

Most of the following models used the lattice connectivity pattern created a uniform distribution of recurrent loops emanating from each neuron, ranging in size from 4 adjacent neurons to all neurons in a given network. The tree pattern is discussed in 3.1.

In all simulations, Iⱼ(0)=0 and wᵢⱼ(0) were sampled randomly and evenly from [−ω, ω]. Network dynamics were initially subcritical for relatively small ω, and supercritical for large ω. A total of 1024 model neurons were connected in a 32×32 lattice. FIG. 2 is a graphical illustration that shows moving average estimates of the critical branching parameter α over the course of tuning for two different values of ω, with Eᵢ(t)=0.01 to provide tonic input to the network (ω=1.0 for the remaining simulations). The graph shows that critical branching is approached when networks begin either from subcritical or supercritical starting points. Pre-synaptic tuning restricts weights slightly under critical branching to avoid saturation.

### 3. Liquid State Machine Results

To assess memory and representational capacity of tuned spiking dynamics, networks were tested on three different classification tasks. The first was to compute the XOR function for external inputs t−τ steps back in time, using only the pattern of spikes produced at time t. XOR assesses the ability of spiking dynamics to separate external inputs, and maintain separation and representation over time. The second task was to compute the parity function over external input sequences τ time steps long, which is nonlinearly separable like XOR, but assesses combination over external input sequences. The third task was noisy pattern classification going t−τ steps back in time, which assesses the ability to collapse across different inputs, rather than separate them. Referring to Appendix, a C program source code (Appendix Section A) was prepared to simulate the noisy pattern classification task and another C program source code (Appendix Section B) was prepared to simulate the XOR and parity tasks. It is to be understood the C program source code is only exemplary and intended to illustrate and not limit the scope of the disclosure.

For the XOR and parity functions, bit sequences were presented as external inputs by choosing half the neurons at random to represent 0, and the other half to represent 1. Bit 0 or 1 was presented to the network at time t−τ by setting Eᵢ(t)=1.0 for all i representing either 0 or 1, respectively. XOR was computed for bits at t−τ and t−τ−1, whereas parity was computed for all bits from t to t−τ. For noisy pattern classification, bit sequences were presented in the same way, except that with probability 0.333, each Eᵢ(t) was added to a randomly chosen neuron i representing the alternate bit value, instead of the correct bit value. The task was to classify the pattern presented at time t−τ.

Networks were tuned for 10000 time steps while bit representations were presented as external inputs. Weights were then frozen and external inputs continued to be presented for another 50000 time steps. Networks produced a pattern of positive and negative spikes over their neurons on each time step, and patterns for four of every five time steps were used to train classifiers. Patterns on the remaining time steps were used to test trained classifiers.

A separate classifier was trained for each classification task, and for each sampled value of τ, ranging from 1 to 10. Gradient descent was used to learn parameters wₚ, and wₙᵢ in

B(t−τ)=Θ(Σsₚᵢ(t)wₚᵢ+Σsₙᵢ(t)wₙᵢ),

where B(t−τ) was the task-specific objective function, Θ was a binary threshold function, sₚᵢ(t) and sₙᵢ(t) were positive and negative spikes produced by neuron i, and Σ ranged over all neurons i. For each classifier, the gradient descent algorithm was run for a total of one million training epochs, at which point error always asymptoted for the training spike patterns.

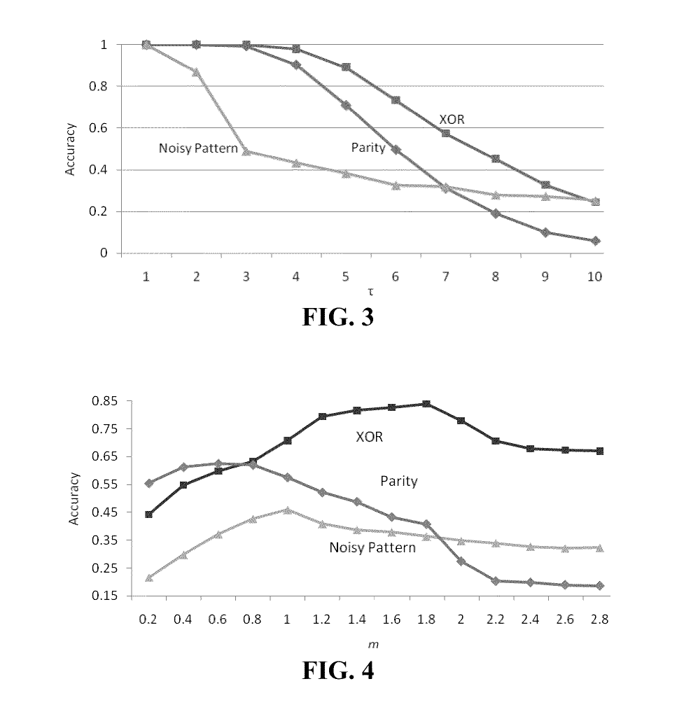

FIG. 3 is a graphical illustration that shows classifier performance as a function of τ for the three different classification tasks, where accuracy is scaled to chance (50%) such that 1 is perfect performance and 0 is chance Networks were 32×32 lattices of neurons (see FIG. 1A) tuned to critical branching.

FIG. 4 is a graphical illustration that shows classifier performance (averaged over r) as a function of distance from critical branching. Networks were first tuned to critical branching, and then weights were uniformly multiplied by m (m<1 for subcritical, m=1 for critical, and m>1 for supercritical). Mean accuracies show a different pattern of performance for each task as a function of critical branching. Critical branching optimized performance for the noisy pattern classification task, but not the other two tasks. XOR performance generally increased as weight magnitudes increased, from subcritical to critical to supercritical, whereas the opposite was true for the parity task. In sum, it appears that critical branching is robust to noise (relative to sub- and supercritical), and strikes a balance between the separation versus combination aspects of XOR versus parity computations.

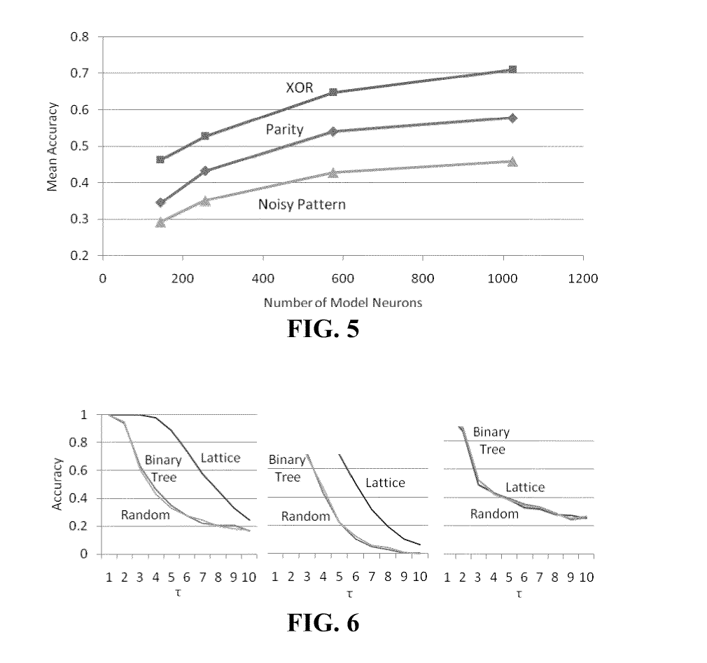

FIG. 5 is a graphical illustration that shows performance for each of classification task plotted as a function of total number of model neurons in the network (for reference, prior networks used 1024 neurons). The data were best fit by a logarithmic function.

3.1 Classification Accuracy and Connectivity

Recent analytic work on reservoir computing has shown that, using sigmoidal neurons, normal connectivity patterns (e.g. translation-invariant like a lattice) have limited memory capacity. However, the above simulations using lattice connectivity exhibited relatively good memory capacity and noise robustness. In fact, the lattice was chosen to create a wide and uniform range of recurrent loops on the hypothesis that they would enhance performance. By contrast, Ganguli et al. showed that the amplification property of feed-forward branching networks creates good memory capacity, at least for sigmoidal output functions (Ganguli et al. (2008) Memory traces in dynamical systems, 18970-5). To provide an initial test of this hypothesis, a lattice network was compared with a randomly connected network (with Kᵢₙ=2 and Kₒᵤₜ=2) and a recurrent binary tree network (see FIG. 1B). The latter balances binary branching, feed-forward connections with random recurrent connections. FIG. 6 shows that lattice connectivity was best for the XOR and parity functions, whereas type of connectivity did not affect noisy pattern classification.

### Example 2

In this example, a self-tuning algorithm is developed for use with leaky integrate-and-fire (LIF) neurons that adjusts postsynaptic weights to a critical branching point between subcritical and supercritical spiking dynamics. The tuning algorithm stabilizes spiking activity in the sense that spikes propagate through the network without multiplying to the point of wildfire activity, and without dying out so quickly that information cannot be transmitted and processed. The critical branching point is also found to maximize memory and representational capacity of the network when used as liquid state machine.

### Self-Tuned Critical-Branching Model

Presented in this example is a model that simulates neural computation near criticality, but in a network of spiking neurons instead of threshold gates. The model includes a self-tuning algorithm that is local to each neurons postsynaptic array, and local in time with respect to each presynaptic firing event and its immediate postsynaptic consequences.

### A. Leaky Integrate-and-Fire Neurons

For each time step t, the membrane potential of every model neuron is determined from the weighted sum of spikes from presynaptic neurons, as well as from external inputs, according to the equation

v^{t+1}=δ[v^{t}∘(1−s^{t})+ε^{t}+(W^{t}−ζI)s^{t}], (6)

where ∘ denotes the Hadamard product (i.e., element-wise multiplication). The notation 1 denotes the column vector of ones. Each term represents:

δ: the leak time constant (set to 0.9);

v^{t}: the membrane potentials of neurons at time t;

ε^{t}: external input/perturbation to v^{t};

W^{t}: the weight matrix between neurons;

ζ: an analogue of the refractory period (set to 1.0);

I: the identity matrix;

s^{t}: the Boolean vector denoting spikes in v^{t}, i.e.,

s^{t}\dot{=}[v^{t}≧1],

using Iverson notation for a Boolean condition.

### Critical Branching Tuning Algorithm

The tuning algorithm adjusts the postsynaptic weights of a given model neuron so that, when it spikes, one and only one spike is expected to follow over the postsynaptic array of neurons. The algorithm weights each descendent spike relative to its number of ancestor spikes n over its presynaptic array on the preceding time step, i.e., 1/n. The algorithm increases weights projecting out from a given postsynaptic neuron by a factor β when the sum of weighted spikes over its postsynaptic array is greater than one. The algorithm decreases weights by β when the sum is less than one (no change is made when equal to one). β was set to 0.01 for all simulations. More formally, the critical branching tuning algorithm can be described by the following equations, presented for readability

c^{t}=S^{t}s^{t}

y^{t}=(c^{t}+ c̅^{t})⁻¹

z^{t+1}=(S^{t})^{T}(s^{t+1}∘y^{t})

n^{t+1}=sgn(1−z^{t+1})

N^{t+1}=1(s^{t}∘n^{t+1})^{T}

Δ^{t+1}=β(S^{t}∘N^{t+1})

W^{t+1}=W^{t}+Δ^{t+1,} (7)

where, letting p^{t}=S^{t}1 denote the number of postsynaptic neurons for each presynaptic neuron in v^{t}, the terms in Equation 7 represent:

S^{t}: the Boolean matrix defined by [W^{t}≠0];

c^{t}: the count of postsynaptic spikes w.r.t. s^{t};

y^{t}: the fraction of postsynaptic spikes to p^{t};

z^{t+1}: the sum of presynaptic terms w.r.t. s^{t+1};

s^{t+1}: the Boolean vector denoting spikes in v^{t+1};

n^{t+1}: the sign of weight updates w.r.t. z^{t+1};

N^{t+1}: the signed outer product w.r.t. s^{t} and n^{t+1};

Δ^{t+1}: the update matrix based on S^{t} and N^{t+1}.

The critical-branching tuning equations do not involve any matrix inversions, and indeed, the update weight matrix is only a function of the Boolean matrix S^{t} and its transpose. Although current research is focused on simplifying the equations further, the current formulation suggests that Equations 1 and 2 should be amenable to analysis for convergence. Also, it is interesting that the state vector S^{t} has a matrix analogue S^{t}, the primary function of which is the computation of presynaptic and postsynaptic spikes. Finally, the notation c^{-t} simply denotes the Boolean complement of c^{-t} to avoid division by zero.

All of the liquid state machine results were obtained using the layered connectivity shown in FIG. 9. External inputs were presented as “forced” spike patterns on the input layer, which consisted of N neurons. Each input layer neuron was randomly connected to m LSM neurons, of which there were 2N in number. Each LSM neuron was randomly connected to 2m LSM and output neurons at random, and there were 2N output neurons. The numbers of neurons and postsynaptic connections were manipulated in some simulations, but unless noted otherwise, m=6 and N=250.

Classifiers were trained on spike patterns over the LSM layer (see below). Classifiers could also be trained on the output layer, and preliminary results suggest that similar performance is obtained for the output layer. However, in the current simulations, the output layer served a different purpose. Output neurons had no post-synaptic connections, which meant that spikes occurring in the output layer “exited” the network. That is, the critical branching algorithm did not count these spikes as ancestors with descendant spikes. Spiking models that are critical branching need a way for spikes to exit the network. Otherwise, as external inputs create spikes, those spike will fill the network to the point of saturation. The reason is that, in a closed recurrent network, perfect critical branching will cause each spike to propagate forever.

### Critical-Branching Results

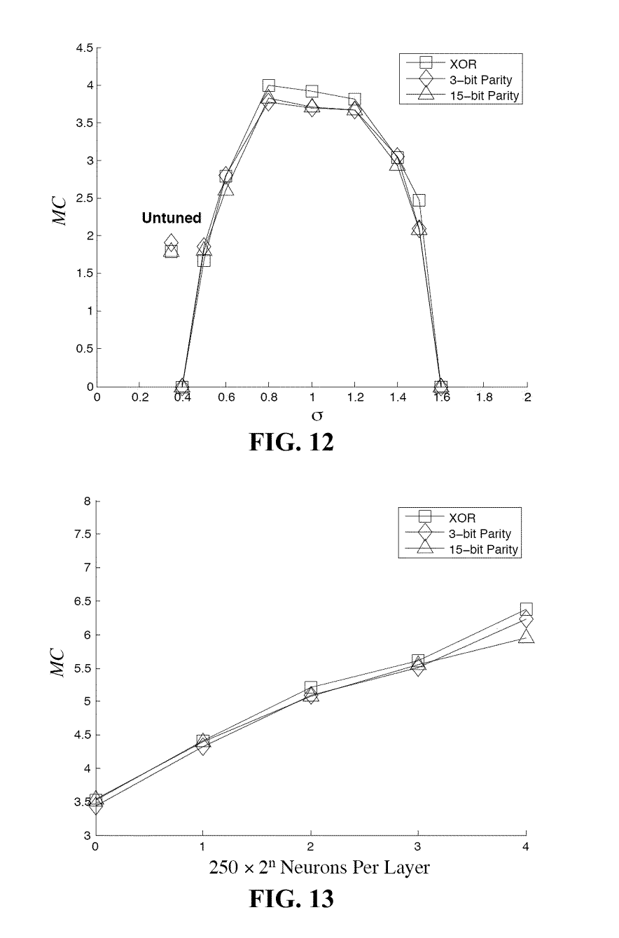

Convergence of the tuning algorithm was tested using the default layered network as described above. Weights were initialized in either a subcritical or supercritical regime by uniformly sampling weights from either a narrow range around zero, [−0:125: 0:125], or around two (FIG. 9). Input layer neurons were divided randomly into two halves, and on each time step, neurons in one of the two halves were forced to spike. For the purpose of testing convergence, this external input procedure was only a means of driving the network with spikes and engaging the tuning algorithm. The two halves of the input layer are used again later to test memory and representational capacity of tuned networks as liquid state machines. Finally, critical branching (σ) was estimated instantaneously by dividing the number of spikes at time t by those at t−1. FIG. 11 shows instantaneous estimates of the critical branching exponent plotted for each time step of simulation (dashed lines are placed at the critical branching points). Weights were initialized around a mean of either 0 (subcritical) or 2 (supercritical). Initial transients are not shown for sake of clarity. FIG. 9 shows that the network quickly converges to critical branching and remains there.

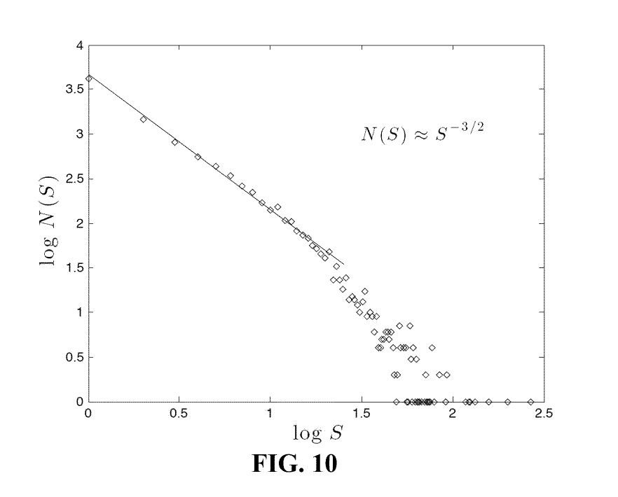

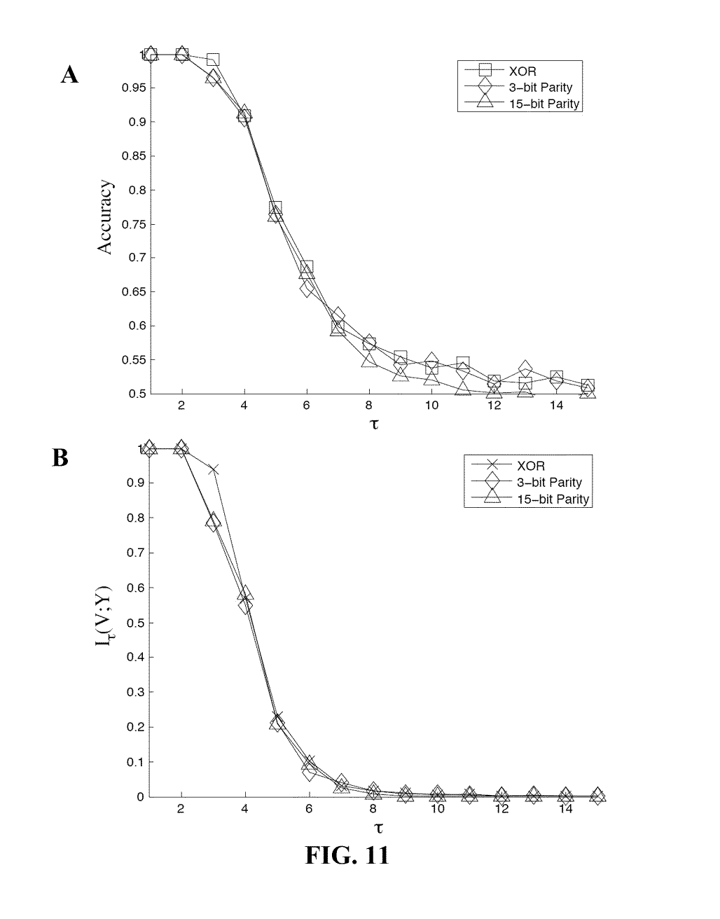

Critical branching is associated with neural avalanches in cortical slice preparations as well as simple probabilistic spiking models. Neural avalanches are observed when network activity is mostly intrinsic, and only occasionally perturbed by small amounts of external input. The layered network prohibits power law distributions in avalanches because spikes exit the network too quickly. Therefore, avalanches were investigated using a single recurrent layer of 1000 neurons, with m=6, and no output layer. Instead of an output layer, spike saturation was avoided by forcing each spike to exit the network with 0.1 probability on each time step. In other words, any given neuron served as an “output” neuron with 0.1 probability when it spiked. The network was tuned to critical branching while driving network activity by forcing each neuron to spike with 0.01 probability on each time step. In other words, any given neuron served as an “input” neuron with 0.01 probability on each time step. Once tuned, the network was driven with “avalanche pings” instead of the procedure just described for initial tuning. To start an avalanche from a silent (i.e. non-spiking) network, a single neuron was forced to spike. Propagated spikes were then counted over time until network activity died out, at which point another neuron was pinged at random, and the process was repeated for 50,000 time steps. Avalanche sizes corresponded to numbers of spikes between pings, and the histogram of avalanche sizes is plotted in FIG. 10 in log-log coordinates. FIG. 10 is a histogram of neural avalanche sizes, plotted in log-log coordinates. A regression line (dashed) was fit to the first 20 points of the distribution, and its resulting slope was ≈−3/2. The figure shows that simulated neural avalanches followed the predicted power law distribution with a −3/2 exponent for most avalanches, i.e., those of small to medium size. The power law fell off for large avalanches due at least in part to limited model size.

### Liquid State Machine Results

To assess memory and representational capacity of tuned spiking dynamics, the layered network was tested on three different classification tasks. The first was to compute the XOR function for external inputs t−τ steps back in time, using only the pattern of spikes produced at time τ. XOR assesses the ability of spiking dynamics to separate external inputs, and maintain separation and representation over time. The second task was to compute the 3-bit parity function over external input sequences τ time steps long, which is nonlinearly separable like XOR, but assesses combinations over successively longer input sequences. The XOR and 3-bit parity tasks include an element of noise, in that intervening bits between τ and the current time step must be ignored. The third task was n-bit parity classification going t−τ steps back in time, which requires memory of all bits going t−τ steps back in time.

For the XOR and 3-bit parity functions, bit sequences were presented as external inputs by choosing half the neurons in the input layer at random to represent 0, and the other half to represent 1. Bit 0 or 1 was presented to the network at time t−τ by setting εᵢ(t−τ)=1 for all i representing either 0 or 1, respectively εᵢ(t−τ)=0, otherwise). Weights were initialized in the range [−1:0; 1:0]. Networks were tuned for 5000 time steps on each of which a bit representation was presented on the input layer as external input. Weights were then frozen and external inputs continued to be presented for another 50000 time steps. Networks produced spike patterns over neurons in their output layers on each time step, and patterns for four of every five time steps were used to train classifiers. Patterns on the remaining time steps were used to test trained classifiers. A separate, non-spiking perceptron classifier was trained for each classification task and each sampled value of τε[1; 15]. Gradient descent was performed on the perceptron weights wᵢ on the task-specific objective function, B(t−τ))=Θ(Σᵢsᵢ(t)wᵢ)), where Θ is a binary threshold function, sᵢ(t) are the spikes produced by neuron i, and Σ ranges over all neurons i. For each classifier, the gradient descent algorithm was run for a total of 1.5 million training epochs, at which point error always reached asymptote for the training spike patterns.

Liquid state machine performance on the three classification tasks was evaluated in terms of accuracy (percent correct), as well as mutual information and a corresponding measure of memory capacity. Memory capacity is defined as the sum, MC=ρ_{τ}I_{τ}(V; Y), of the mutual information, I_{τ}(V; Y) between classifier output, v_{τ}(•) trained on a delay of τ time steps, and the target function, y_{τ}(•). FIG. 11 shows liquid state fading memory capacity (τ) for three different functions: XOR, 3-bit parity, and n-bit parity classification. Panel A shows performance in terms of accuracy. Panel B shows the performance in terms of mutual information, I(V; Y). FIG. 11 shows classifier performance in terms of accuracy as well as mutual information, I_{τ}(V; Y), as a function of τ. In addition to its ability to capture nonlinear correlations in temporal classification tasks, mutual information has the additional advantage in that it is naturally linear: that is, I_{τ}(V; Y) lends itself to simple summation over any range of delays because it is based on logarithms. In particular, mutual information relates two random variables, V and Y, with respect to the joint and marginal distributions of their possible outcomes. Mutual information is defined as

$$I ( V ; Y ) = {\sum }_{v}^{{ }^{′}} {\sum }_{y}^{{ }^{′}} p ( {v}^{′} , {y}^{′} ) lg \frac{p ( {v}^{′} , {y}^{′} )}{p ( {v}^{′} ) p ( {y}^{′} )} \qquad ( 8 )$$

where p(v′,y′) represents the joint probability that V has outcome v′ and Y′, outcome y′, while p(v′) and p(y′) are the marginal probabilities of the random variables. More precisely,

p(v′,y′)=P(V=v′ΛY=y′) (9)

is the joint probability for each possible pair of outcomes, and

p(v′)=P(V=v′) and p(y′)=P(Y=y′) (10)

are the marginal probabilities of the outcomes alone. If V and Y are statistically independent, then p(v′,y′)=p(v′)p(y′), in which case the rational argument of the logarithm in Equation 8 is 1 and I(V; Y) is accordingly 0.

FIG. 12 shows liquid state performance for the three different classification tasks (XOR, 3-bit parity, and n-bit parity) plotted as a function of estimated σ after tuning with biased towards subcritical (left of σ=1) or supercritical (right of σ=1). Memory capacity is plotted from τε[1; 15], and m=6 for this simulation. Thus, FIG. 12 shows liquid state performance as a function of tuning to subcritical, critical, and supercritical dynamics. Tuning was manipulated by making weight changes away from critical with some probability. Subcritical versus supercritical dynamics were tuned by biasing weight changes in one direction or the other with uniform probability in the range [0.0:0.6]. This bias was used to achieve a range of σ estimates. FIG. 12 shows that performance was maximized near the critical branching point σ≈1.

FIG. 13 shows liquid state performance in terms of MC for the three different classification tasks (XOR, 3-bit parity, and n-bit parity) plotted as a function of number of neurons per LSM layer (250, 500, 1000, 2000, and 4000). Thus, FIG. 13 shows the effect of total number of model neurons on liquid state performance at the critical branching point.

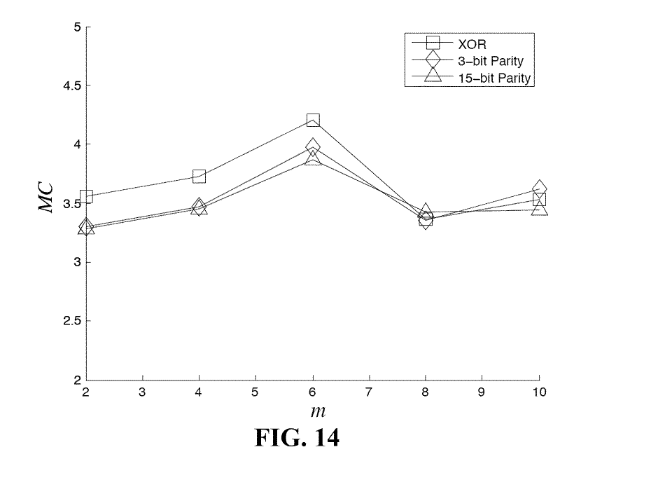

Finally, FIG. 14 shows the effect of number of postsynaptic connections on performance after tuning to the critical branching point. Overall, performance was not greatly affected in the range of m from 2 to 10 postsynaptic connections per input neuron (i.e., 4 to 20 per LSM and output neuron), but performance was slightly maximal at m=6. FIG. 14 shows liquid state performance for the three different classification tasks (XOR, 3-bit parity, and n-bit parity) plotted in terms of MC as a function of the number of postsynaptic connections (m) on the input layer (2m on the LSM and output layers).

This example shows a network of leaky integrate-and-fire neurons self-tuned to a critical-branching point using an algorithm that is local to each model neuron and its postsynaptic array. This model simulated neural avalanches that are predicted by critical branching, and have been demonstrated in cortical activity measured in vivo and in vitro. This model also showed maximal performance as a liquid state machine when tuned to critical branching. Thus the model relates stability of spiking dynamics with memory and representational capacity.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A system, comprising a network of artificial neurons interconnected by connections, wherein:
each artificial neuron is configured to receive an input signal from and send an output signal to one or more of the other artificial neurons through one of the connections;
each input and output signal is either positive or negative valued; and
each artificial neuron has an activation at a time point, the activation being determined by at least input signals received by the artificial neuron, output signals sent by the artificial neuron, and a plurality of weights, wherein at least one weight is self-tuned at the time point.

2. The system of claim 1, further comprising an external signal device connected to the network of artificial neurons, wherein one or more artificial neurons is configured to receive an input signal from the external signal device.

3. The system of claim 2, wherein the external signal device is a memory.

4. The system of claim 1, further comprising an external receiving device connected to the network of artificial neurons, wherein one or more artificial neurons sends an output signal to the external receiving device.

5. The system of claim 1, further comprising a control unit, the control unit having a connection to each artificial neuron.

6. The system of claim 5, wherein the control unit is configured to receive a data signal from one or more artificial neurons and send a command signal to one or more artificial neurons.

7. The system of claim 1, wherein the input signals determining the activation of the artificial neuron are input signals received by the artificial neuron at a prior time point preceding the time point.

8. The system of claim 1, wherein the output signals determining the activation of the artificial neuron are output signals sent by the artificial neuron at a prior time point preceding the time point.

9. The system of claim 1, wherein each connection is a unidirectional connection.

10. The system of claim 1, wherein each weight is independently self-tuned.

11. The system of claim 1, wherein each weight is self-tuned at the time point so that a non-zero output signal sent by each artificial neuron is followed by one non-zero output signal among all artificial neurons to which the artificial neuron sends an output signal.

12. The system of claim 11, wherein the non-zero output signal is a spike.

13. The system of claim 1, wherein the activation of each artificial neuron is not directly based on the activation of other artificial neurons or input or output signals not received or sent by the artificial neuron.

14. The system of claim 1, wherein the activation of each artificial neuron is determined according to Equation (1):
$${I}_{j} ( t + 1 ) = - {s}_{j} ( t ) + {I}_{j} ( t ) + {E}_{j} ( t ) + {\sum }_{i = 1}^{{pre}_{j}} {w}_{ij} ( t ) {s}_{i} ( t ) \qquad ( 1 )$$
wherein:
Iⱼ(t+1) is the activation for artificial neuron j at time t+1;
sⱼ(t) is the output signal of artificial neuron j at time t;
Eⱼ(t) is an optional external input signal to artificial neuron j at time t;
sᵢ(t) is the output signal of artificial neuron i at time t;
wᵢⱼ(t) is the weight associated with sᵢ(t) at time t; and
preⱼ indexes the artificial neurons that send output signals to artificial neuron j.

15. The system of claim 1, wherein the output signal sent by at least one artificial neuron is determined by at least the activation of the artificial neuron and a threshold parameter.

16. The system of claim 15, wherein the threshold parameter is pre-determined.

17. The system of claim 15, wherein the threshold parameter is self-tuned.

18. The system of claim 15, wherein the output signal is determined according to Equation (2):
$${s}_{j} ( t + 1 ) = \{ \begin{matrix}θ , & {I}_{j} ( t ) \geq θ \\ - θ , & {I}_{j} ( t ) \leq - θ \\ 0 , & - θ < {I}_{j} ( t ) < θ\end{matrix} \qquad ( 2 )$$
wherein:
sⱼ(t+1) is the output signal of artificial neuron j at time t+1;
Iⱼ(t) is the activation of artificial neuron j at time t; and
θ is the threshold parameter.

19. The system of claim 1, wherein each weight is determined according to Equation (3):
$${w}_{ij} ( t + 1 ) = {w}_{ij} ( t ) + sgn ( {w}_{ij} ( t ) ) \times \{ \begin{matrix}β , & {N}_{i} ( t + 1 ) = 0 \\ 0 , & {N}_{i} ( t + 1 ) = 1 \\ - β , & {N}_{i} ( t + 1 ) > 1\end{matrix} \qquad ( 3 )$$
wherein:
wᵢⱼ(t+1) is the weight associated with sᵢ(t+1) at time t+1;
wᵢⱼ(t) is the weight associated with sᵢ(t) at time t;
sgn( ) is a signum function;
β is a weight change parameter; and
Ni(t+1) is determined according to Equation (4):
$${N}_{i} ( t + 1 ) = {\sum }_{j = 1}^{{post}_{i}} \{ \begin{matrix}1 , & {s}_{i} ( t ) \times sgn ( {w}_{ij} ( t ) ) = {s}_{j} ( t + 1 ) \\ 0 , & {s}_{i} ( t ) \times sgn ( {w}_{ij} ( t ) ) \neq {s}_{j} ( t + 1 )\end{matrix} \qquad ( 4 )$$
wherein:
postᵢ indexes the artificial neurons that artificial neuron i sends an output signal to;
sᵢ(t) is the output signal of artificial neuron i; and
sⱼ(t+1) is the output signal of artificial neuron j.

20. The system of claim 1, wherein each weight is determined according to Equations (3) and (4), with the proviso that when sᵢ(t)=sᵢ(t−1)≠0, then the weight is determined according to Equation (5):
$${w}_{ij} ( t + 1 ) = {w}_{ij} ( t ) - γ \times sgn ( {w}_{ij} ( t ) ) \times \{ \begin{matrix}1 , & {s}_{j} ( t ) {s}_{j} ( t + 1 ) = {θ}^{2} \\ 0 , & {s}_{j} ( t ) {s}_{j} ( t + 1 ) \neq {θ}^{2}\end{matrix} \qquad ( 5 )$$
wherein:
γ is a weight change parameter;
θ is a threshold parameter;
wᵢⱼ(t+1) is the weight associated with sᵢ(t+1) at time t+1;
wᵢⱼ(t) is the weight associated with sᵢ(t) at time t;
sⱼ(t) is the output signal of artificial neuron j at time t;
sⱼ(t+1) is the output signal of artificial neuron j at time t+1; and
sgn( ) is a signum function.

21. The system of claim 1, wherein the activation of each artificial neuron is determined according to Equation (6):
v^{t+1}=δ[v^{t}∘(1−s^{t})+ε^{t}+(W^{t}−ζI)s^{t}], (6)
wherein:
∘ denotes the Hadamard product;
the notation 1 denotes the column vector of ones;
δ denotes the leak time constant;
v^{t} denotes the membrane potentials of neurons at time t;
ε^{t} denotes the external input/perturbation to v^{t};
W^{t} denotes the weight matrix between neurons;
ζ is an analogue of the refractory period;
I denotes the identity matrix; and
s^{t} denotes the Boolean vector denoting spikes in v^{t}, and is determined as
s^{t}\dot{=}[v^{t}≧1],
using Iverson notation for a Boolean condition.

22. The system of claim 1, wherein at least one input or output signal is an electrical signal.

23. The system of claim 1, wherein at least one input or output signal is a digital signal.

24. The system of claim 1, wherein each artificial neuron is an electrical circuit.

25. The system of claim 1, wherein the network of artificial neurons is a physical neuron network liquid state machine.

26. The system of claim 1, wherein the network of artificial neurons is implemented on a semiconductor chip.

27. A computational system, comprising:
a processor;
a memory coupled to the processor;
computer code, loaded into the memory for execution on the processor, for implementing an artificial neural network, the artificial neural network having a plurality of artificial neurons interconnected by connections, wherein:
each neuron is configured to receive an input signal from and send an output signal to one or more of the other artificial neurons through one of the connections;
each input and output signal is either positive or negative valued; and
each artificial neuron has an activation at a time point, the activation being determined by at least input signals received by the neuron, output signals sent by the neuron, and a plurality of weights, wherein at least one weight is self-tuned at the time point.

28. The computational system of claim 27, wherein the artificial neural network further comprises an external signal device connected to the network, wherein one or more artificial neurons is configured to receive an input signal from the external signal device.

29. The computational system of claim 28, wherein the external signal device is a memory.

30. The computational system of claim 27, wherein the artificial neural network further comprises an external receiving device connected to the network, wherein one or more artificial neurons sends an output signal to the external receiving device.

31. The computational system of claim 27, wherein the artificial neural network further comprises a control unit, the control unit having a connection to each artificial neuron.

32. The computational system of claim 31, wherein the control unit is configured to receive a data signal from one or more artificial neurons and send a command signal to one or more artificial neurons.

33. The computational system of claim 27, wherein the input signals determining the activation of the artificial neuron are input signals received by the artificial neuron at a prior time point preceding the time point.

34. The computational system of claim 27, wherein the output signals determining the activation of the artificial neuron are output signals sent by the artificial neuron at a prior time point preceding the time point.

35. The computational system of claim 27, wherein each connection is a unidirectional connection.

36. The computational system of claim 27, wherein each weight is independently self-tuned.

37. The computational system of claim 27, wherein each weight is self-tuned at a time point so that a non-zero output signal sent by each artificial neuron is followed by one non-zero output signal among all artificial neurons to which the artificial neuron sends an output signal.

38. The computational system of claim 37, wherein the non-zero output signal is a spike.

39. The computational system of claim 27, wherein the activation of each artificial neuron is not directly based on the activation of other artificial neurons or input or output signals not received or sent by the artificial neuron.

40. The computational system of claim 27, wherein the activation of each artificial neuron is determined according to Equation (1).

41. The computational system of claim 27, wherein the output signal sent by each artificial neuron is determined by at least the activation of the artificial neuron and a threshold parameter.

42. The computational system of claim 41, wherein the threshold parameter is pre-determined.

43. The computational system of claim 42, wherein the threshold parameter is self-tuned.

44. The computational system of claim 41, wherein the output signal is determined according to Equation (2).

45. The computational system of claim 27, wherein the weights are determined according to Equations (3) and (4).

46. The computational system of claim 27, wherein each weight is determined according to Equations (3) and (4), with the proviso that when sᵢ(t)=sᵢ(t−1)≠0, then the weight is determined according to Equation (5).

47. The computational system of claim 27, wherein the activation of each artificial neuron is determined according to Equation (6).

48. The computational system of claim 27, wherein at least one input or output signal is a digital signal.

49. A method for tuning a network of artificial neurons interconnected by connections, wherein each artificial neuron is configured to receive an input signal from and send an output signal to one or more of the other artificial neurons through one of the connections, comprising:
generating an activation for each artificial neuron at a time point based on:
1) input signals received by the artificial neuron;
2) output signals sent from the artificial neuron; and
3) a plurality of weights, wherein at least one weight is self-tuned at the time point.

50. The method of claim 49, wherein each input signal received by the artificial neuron is positive or negative valued.

51. The method of claim 49, wherein each output signal sent from the artificial neuron is positive or negative valued.

52. The method of claim 49, wherein the input signals determining the activation of the artificial neuron are input signals received by the artificial neuron at a prior time point preceding the time point.

53. The method of claim 49, wherein the output signals determining the activation of the artificial neuron are output signals sent by the artificial neuron at a prior time point preceding the time point.

54. The method of claim 49, wherein each weight is independently self-tuned.

55. The method of claim 49, wherein each weight is self-tuned at a time point so that a non-zero output signal sent by each artificial neuron is followed by one non-zero output signal among all artificial neurons to which the artificial neuron sends an output signal.

56. The method of claim 55, wherein the non-zero output signal is a spike.

57. The method of claim 49, wherein the activation of each artificial neuron is not directly based on the activation of other artificial neurons or input or output signals not received or sent by the artificial neuron.

58. The method of claim 49, wherein the activation is based on an algorithm according to Equation (1).

59. The method of claim 49, wherein the output signal sent by each artificial neuron is determined by at least the activation of the artificial neuron and a threshold parameter.

60. The method of claim 59, wherein the threshold parameter is pre-determined.

61. The method of claim 59, wherein the threshold parameter is self-tuned.

62. The method of claim 59, wherein the output signal is determined according to Equation (2).

63. The method of claim 49, wherein each weight is determined according to Equations (3) and (4).

64. The method of claim 49, wherein each weight is determined according to Equations (3) and (4), with the proviso that when sᵢ(t)=sᵢ(t−1)≠0, then the weight is determined according to Equation (5).

65. The method of claim 49, wherein the activation is based on an algorithm according to Equation (6).

66. The method of claim 49, wherein each input and output signal is an electrical signal.

67. The method of claim 49, wherein at least one input or output signal is a digital signal.

68. The method of claim 49, wherein each artificial neuron is an electrical circuit.

69. The method of claim 49, wherein each artificial neuron is a computer-simulated neuron.

70. The method of claim 49, wherein each artificial neuron is an electrically-simulated neuron.

71. The method of claim 49, wherein the network of artificial neurons is a physical neuron network liquid state machine.

72. The method of claim 49, wherein the network of artificial neurons is implemented on a semiconductor chip.

73. A non-transitory computer readable storage medium including one or more instructions executable by a processor for implementing a self-tuned neural network, wherein the self-tuned neural network comprises a plurality of artificial neurons interconnected by connections, the non-transitory computer readable storage medium comprising one or more instructions for:
each artificial neuron receiving an input signal from and sending an output signal to one or more of the other artificial neurons through one of the connections, wherein each input and output signal is positive or negative valued; and
each artificial neuron having an activation at a time point, the activation being determined by at least input signals received by the artificial neuron, output signals sent by the artificial neuron, and a plurality of weights, wherein at least one weight is self-tuned at the time point.
